(19) United States
(12) Patent Application Publication
(10) Pub. No.: US 2024/0182790 A1
(43) Pub. Date: Jun. 6, 2024

(54) METHOD FOR PREPARING AROMATIC HYDROCARBON-RICH PYROLYTIC OIL BY CATALYTIC PYROLYSIS OF WASTE MASK

(71) Applicant: TIANJIN UNIVERSITY, Jinnan District (CN)

(72) Inventors: Zhanjun Cheng, Jinnan District (CN); Hui Zhou, Jinnan District (CN); Beibei Yan, Jinnan District (CN); Guanyi Chen, Jinnan District, Tianjin (CN)

(21) Appl. No.: 18/214,777

(22) Filed: Jun. 27, 2023

(30) Foreign Application Priority Data
Dec. 6, 2022 (CN) 202211557255.9

(51) Int. Cl. C10G 1/00; B01J 29/40; B01J 29/46; B01J 37/02; B01J 37/08

(52) U.S. Cl. CPC C10G 1/00; B01J 29/405; B01J 29/46; B01J 37/0201; B01J 37/0236; B01J 37/088; B01J 2229/186; C10G 2300/1003; C10G 2300/70

(57) ABSTRACT

Provided is a method for preparing an aromatic hydrocarbon-rich pyrolytic oil by catalytic pyrolysis of a waste mask, which relates to the technical field of waste treatment and resource utilization. The method includes: mixing the waste mask with a metal supported HZSM-5 molecular sieve catalyst to form a mixture; and subjecting the mixture to a catalytic pyrolysis reaction in a protective atmosphere to obtain the aromatic hydrocarbon-rich pyrolytic oil.

### CROSS REFERENCE TO RELATED APPLICATION

This application claims the benefit and priority of Chinese Patent Application No. 202211557255.9, entitled “Method for preparing aromatic hydrocarbon-rich pyrolytic oil by catalytic pyrolysis of waste mask” filed on Dec. 6, 2022, the disclosure of which is incorporated by reference herein in its entirety as part of the present application.

### TECHNICAL FIELD

The present disclosure relates to the technical field of waste treatment and resource utilization, in particular to a method for preparing an aromatic hydrocarbon-rich pyrolytic oil by catalytic pyrolysis of a waste mask.

### BACKGROUND ART

Disposable masks are one of the most common personal protective supplies. Since novel coronavirus pneumonia became a global epidemic, in order to prevent the virus from spreading from person to person, the demand and also the abandonment of disposable masks have been sharply increased. Discarded masks may also have the risk of virus infection. Traditional treatment such as incineration and burial may cause the occupation of land resources and the emission of toxic and harmful gases, and fails to realize the resource utilization of the discarded disposable masks, which pollutes the environment and meanwhile causes waste of resources. Therefore, it is of great significance to develop a method for preparing an aromatic hydrocarbon-rich pyrolytic oil by catalytic pyrolysis of a waste mask.

### SUMMARY

The present disclosure provides a method for preparing an aromatic hydrocarbon-rich pyrolysis oil by catalytic pyrolysis of a waste mask, so as to solve the technical problem that the waste mask in the prior art cannot be utilized as resources.

In order to solve the technical problem above, the present disclosure provides the following technical solution:

A method for preparing an aromatic hydrocarbon-rich pyrolytic oil by catalytic pyrolysis of a waste mask, comprising the steps of:
mixing the waste mask with a catalyst to form a mixture; and
subjecting the mixture to a catalytic pyrolysis reaction in a protective atmosphere to obtain the aromatic hydrocarbon-rich pyrolytic oil;
wherein the catalyst is a metal supported HZSM-5 molecular sieve catalyst.

In some embodiments, a metal in the metal supported HZSM-5 molecular sieve catalyst is one or more selected from the group consisting of gallium, zinc, nickel, iron and copper, and has a loading amount of 1-20 wt %.

In some embodiments, the metal supported HZSM-5 molecular sieve catalyst is prepared by a process comprising
subjecting an HZSM-5 molecular sieve to impregnation in a metal salt solution to obtain an impregnated HZSM-5 molecular sieve; and
subjecting the impregnated HZSM-5 molecular sieve to drying and calcination sequentially to obtain the metal supported HZSM-5 molecular sieve catalyst.

In some embodiments, the metal salt solution is prepared from a metal salt and water, and a solid-liquid ratio of the metal salt to water is in a range of (3-12) g: (160-240) mL, and the metal salt is one or more selected from the group consisting of gallium nitrate, zinc nitrate, nickel nitrate, iron nitrate and copper nitrate.

In some embodiments, the impregnation is conducted at a temperature of 60-85° C. for 4-6 h.

In some embodiments, the drying is conducted at a temperature of 100-120° C. for 12-24 h.

In some embodiments, the calcination is conducted at a temperature of 500-600° C. for 4-8 h.

In some embodiments, a mass ratio of the waste mask to the catalyst is in a range of 1:1 to 10:1.

In some embodiments, a protective atmosphere is provided by nitrogen or argon with a flow rate of 100-400 mL/min.

In some embodiments, the catalytic pyrolysis reaction is conducted at a temperature of 500-700° C. for 5-30 min.

The present disclosure has the following advantages:
(1) In the present disclosure, provided is a method for preparing an aromatic hydrocarbon-rich pyrolytic oil by catalytic pyrolysis of a waste mask. The aromatic hydrocarbon-rich pyrolytic oil obtained from the method has a high level of monocyclic aromatic hydrocarbons, which is convenient for subsequent separation and purification. The deactivation of the metal supported HZSM-5 sieve catalyst used in the method is improved and the catalyst may be reused.
(2) The method for preparing an aromatic hydrocarbon-rich pyrolysis oil by catalytic pyrolysis of a waste mask could convert waste disposable masks into hydrocarbon-rich fuel oil, thereby realizing resource utilization of waste disposable masks. The method has a simple and clean production process. Also, the reaction temperature can fully eliminate virus, thereby preventing secondary pollution.

### DETAILED DESCRIPTION OF THE EMBODIMENTS

In the present disclosure, provided is a method for preparing an aromatic hydrocarbon-rich pyrolytic oil by catalytic pyrolysis of a waste mask, comprising the steps of:
mixing the waste mask with a catalyst to form a mixture; and
subjecting the mixture to a catalytic pyrolysis reaction in a protective atmosphere to obtain the aromatic hydrocarbon-rich pyrolytic oil;
wherein the catalyst is a metal supported HZSM-5 molecular sieve catalyst.

In some embodiments, a metal in the metal supported HZSM-5 molecular sieve catalyst is one or more selected from the group consisting of gallium, zinc, nickel, iron and copper; preferably, the metal is one or more selected from the group consisting of gallium, nickel, and copper; more preferably, the metal is gallium and/or nickel. In some embodiments, the metal has a loading amount of 1-20 wt %, preferably 5-15 wt %, and more preferably 10 wt %.

In some embodiments, the metal supported HZSM-5 molecular sieve catalyst is prepared by a process comprising the following steps:
subjecting an HZSM-5 molecular sieve to impregnation in a metal salt solution to obtain an impregnated HZSM-5 molecular sieve; and
subjecting the impregnated HZSM-5 molecular sieve to drying and calcination sequentially to obtain the metal supported HZSM-5 molecular sieve catalyst.

In some embodiments, the HZSM-5 molecular sieve is calcined in a muffle furnace before the impregnation at a temperature of 550° C. for 2 h.

In some embodiments, the metal salt solution is prepared from a metal salt and water, and a solid-liquid ratio of the metal salt to water is in a range of (3-12) g: (160-240) mL, preferably (4-11) g: (180-220) mL, and more preferably, 11 g: 200 mL.

In some embodiments, the metal salt is one or more selected from the group consisting of gallium nitrate, zinc nitrate, nickel nitrate, iron nitrate and copper nitrate; preferably, the metal salt is one or more selected from the group consisting of gallium nitrate, nickel nitrate and copper nitrate; more preferably, the metal salt is at least one selected from the group consisting of gallium nitrate and nickel nitrate.

In some embodiments, the impregnation is conducted at a temperature of 60-85° C., preferably 65-80° C., and more preferably 70-75° C. In some embodiments, the impregnation is conducted for 4-6 h, preferably 4.5-5.5 h, and more preferably 5 h.

In some embodiments, the drying is conducted at a temperature of 100-120° C., preferably 105-115° C., and more preferably 110° C. In some embodiments, the drying is conducted for 12-24 h, preferably 14-22 h, and more preferably 16-20 h.

In some embodiments, the calcination is conducted at a temperature of 500-600° C., and preferably 550° C. In some embodiments, the calcination is conducted for 4-8 h, preferably 4.5-7.5 h, and more preferably 5-7 h.

In some embodiments, a mass ratio of the waste mask to the catalyst is in a range of 1:1 to 10:1, preferably 3:1 to 8:1, and more preferably 5:1.

In some embodiments, the protective atmosphere is provided by nitrogen or argon. In one embodiment, the protective atmosphere is provided by a gas in a flow rate of 100-400 mL/min, preferably 150-350 mL/min, and more preferably 200-300 mL/min.

In some embodiments, the catalytic pyrolysis reaction is conducted at a temperature of 500-700° C., preferably 550-650° C., and more preferably 600° C. In some embodiments, the catalytic pyrolysis reaction is conducted for 5-30 min, preferably 10-25 min, and more preferably 15-20 min.

The technical solutions according to the present disclosure will be described in detail in conjunction with the examples below, but the examples cannot be understood as a limitation to the scope of the present disclosure.

### Example 1

A gallium nitrate solution was prepared by dissolving 7.32 g of gallium nitrate in 200 mL of deionized water. 20 g of calcined HZSM-5 molecular sieve was impregnated in the gallium nitrate solution at 60° C. for 4 h, to obtain an impregnated HZSM-5 molecular sieve. After impregnation, the impregnated HZSM-5 molecular sieve was then dried at 100° C. for 16 h, and finally calcined at 550° C. for 6 h, to obtain a gallium supported HZSM-5 molecular sieve catalyst with the gallium loading amount of 10 wt %.

1 g of a smashed waste mask was put onto a fixed bed, and then 1 g of 10 wt % gallium supported HZSM-5 sieve catalyst as described above was added onto the fixed bed. After uniformly mixing, the resulting mixture was subjected to a catalytic pyrolysis reaction in nitrogen protective atmosphere with a nitrogen flow rate of 100 mL/min at a temperature of 550° C. for 15 min. The pyrolysis reaction product was subjected to gas-liquid-solid separation to obtain a liquid phase product (i.e., hydrocarbon-rich fuel oil), gas, and a small amount of pyrolysis carbon. The liquid phase product was subjected to GCMS detection. The product distribution results obtained are shown in Table 1.

### Example 2

A zinc nitrate solution was prepared by dissolving 9.12 g of zinc nitrate in 200 mL of deionized water, and then 20 g of calcined HZSM-5 molecular sieve was impregnated in the zinc nitrate solution at 85° C. for 6 h, to obtain an impregnated HZSM-5 molecular sieve. After impregnation, the impregnated HZSM-5 molecular sieve was then dried at 120° C. for 12 h after impregnation, and finally calcined at 600° C. for 4 h, to obtain zinc supported HZSM-5 molecular sieve catalyst with the zinc loading amount of 10 wt %.

1 g of a smashed waste mask was put onto a fixed bed, and then 1 g of 10 wt % zinc supported HZSM-5 sieve catalyst as described above was added onto the fixed bed. After uniformly mixing, the resulting mixture was subjected to a catalytic pyrolysis reaction in nitrogen protective atmosphere with a nitrogen flow rate of 100 mL/min at a temperature of 550° C. for 15 min. The pyrolysis reaction product was subjected to gas-liquid-solid separation to obtain liquid phase product (i.e., hydrocarbon-rich fuel oil), gas, and a small amount of pyrolysis carbon. The liquid phase product was subjected to GCMS detection. The product distribution results obtained are shown in Table 1.

### Example 3

A nickel nitrate solution was prepared by dissolving 9.86 g of nickel nitrate in 200 mL of deionized water, and then 20 g of calcined HZSM-5 molecular sieve was impregnated in the nickel nitrate solution at 70° C. for 5 h, to obtain an impregnated HZSM-5 molecular sieve. After impregnation, the impregnated HZSM-5 molecular sieve was then dried at 110° C. for 20 h, and finally calcined at 500° C. for 5 h, to obtain nickel supported HZSM-5 molecular sieve catalyst with the nickel loading amount of 10 wt %.

1 g of a smashed waste mask was put onto a fixed bed, and then 1 g of 10 wt % nickel supported HZSM-5 sieve catalyst as described above was added onto the fixed bed. After uniformly mixing, the resulting mixture was subjected to a catalytic pyrolysis reaction in nitrogen protective atmosphere with a nitrogen flow rate of 100 mL/min at a temperature of 550° C. for 15 min. The pyrolysis reaction product was subjected to gas-liquid-solid separation to obtain liquid phase product (i.e., hydrocarbon-rich fuel oil), gas and a small amount of pyrolysis carbon. The liquid phase product was subjected to GCMS detection. The product distribution results obtained are shown in Table 1.

### Example 4

An iron nitrate solution was prepared by dissolving 8.64 g of iron nitrate in 200 mL of deionized water, and then 20 g of calcined HZSM-5 molecular sieve was impregnated in the gallium nitrate solution at 65° C. for 4 h, to obtain an impregnated HZSM-5 molecular sieve. After impregnation, the impregnated HZSM-5 molecular sieve was then dried at 105° C. for 24 h, and finally calcined at 550° C. for 6 h, to obtain an iron supported HZSM-5 molecular sieve catalyst with the iron loading amount of 10 wt %.

1 g of a smashed waste mask was put onto a fixed bed, and then 1 g of 10 wt % iron supported HZSM-5 sieve catalyst as described above was added onto the fixed bed. After uniformly mixing, the resulting mixture was subjected to a catalytic pyrolysis reaction in nitrogen protective atmosphere with a nitrogen flow rate of 100 mL/min at a temperature of 550° C. for 15 min. The pyrolysis reaction product was subjected to gas-liquid-solid separation to obtain a liquid phase product (i.e., hydrocarbon-rich fuel oil), gas, and a small amount of pyrolysis carbon. The liquid phase product was subjected to GCMS detection. The product distribution results obtained are shown in Table 1.

### Example 5

A copper nitrate solution was prepared by dissolving 5.875 g of copper nitrate in 200 mL of deionized water, and then 20 g of calcined HZSM-5 molecular sieve was impregnated in the gallium nitrate solution at 80° C. for 4 h, to obtain an impregnated HZSM-5 molecular sieve. After impregnation, the impregnated HZSM-5 molecular sieve was then dried at 115° C. for 18 h, and finally calcined at 550° C. for 6 h, to obtain copper supported HZSM-5 molecular sieve catalyst with the copper loading amount of 10 wt %.

1 g of a smashed waste mask was put onto a fixed bed, and then 1 g of 10 wt % copper supported HZSM-5 sieve catalyst as described above was added onto the fixed bed. After uniformly mixing, the resulting mixture was subjected to a catalytic pyrolysis reaction in nitrogen protective atmosphere with a nitrogen flow rate of 100 mL/min at a temperature of 550° C. for 15 min. The pyrolysis reaction product was subjected to gas-liquid-solid separation to obtain a liquid phase product (i.e., hydrocarbon-rich fuel oil), gas, and a small amount of pyrolysis carbon. The liquid phase product was subjected to GCMS detection. The product distribution results obtained are shown in Table 1.

### Example 6

A gallium nitrate solution was prepared by dissolving 3.66 g of gallium nitrate in 200 mL of deionized water, and then 20 g of calcined HZSM-5 molecular sieve was impregnated in the gallium nitrate solution at 60° C. for 4 h, to obtain an impregnated HZSM-5 molecular sieve. After impregnation, the impregnated HZSM-5 molecular sieve was then dried at 100° C. for 16 h, and finally calcined at 550° C. for 6 h, to obtain gallium supported HZSM-5 molecular sieve catalyst with the gallium loading amount of 5 wt %.

1 g of a smashed waste mask was put onto a fixed bed, and then 1 g of 5 wt % gallium supported HZSM-5 sieve catalyst as described above was added onto the fixed bed. After uniformly mixing, the resulting mixture was subjected to a catalytic pyrolysis reaction in nitrogen protective atmosphere with a nitrogen flow rate of 100 mL/min at a temperature of 550° C. for 15 min. The pyrolysis reaction product was subjected to gas-liquid-solid separation to obtain a liquid phase product (i.e., hydrocarbon-rich fuel oil), gas and a small amount of pyrolysis carbon. The liquid phase product was subjected to GCMS detection. The product distribution results obtained are shown in Table 1.

### Example 7

A gallium nitrate solution was prepared by dissolving 10.98 g of gallium nitrate in 200 mL of deionized water, and then 20 g of calcined HZSM-5 molecular sieve was impregnated in the gallium nitrate solution at 60° C. for 4 h, to obtain an impregnated HZSM-5 molecular sieve. After impregnation, the impregnated HZSM-5 molecular sieve was then dried at 100° C. for 16 h, and finally calcined at 550° C. for 6 h, to obtain gallium supported HZSM-5 molecular sieve catalyst with the gallium loading amount of 15 wt %.

1 g of a smashed waste mask was put onto a fixed bed, and then 1 g of 15 wt % gallium supported HZSM-5 sieve catalyst as described above was added onto the fixed bed. After uniformly mixing, the resulting mixture was subjected to a catalytic pyrolysis reaction in nitrogen protective atmosphere with a nitrogen flow rate of 100 mL/min at a temperature of 550° C. for 15 min. The pyrolysis reaction product was subjected to gas-liquid-solid separation to obtain a liquid phase product (i.e., hydrocarbon-rich fuel oil), gas, and a small amount of pyrolysis carbon. The liquid phase product was subjected to GCMS detection. The product distribution results obtained are shown in Table 1.

### Example 8

A gallium nitrate solution was prepared by dissolving 7.32 g of gallium nitrate in 250 mL of deionized water, and then 20 g of calcined HZSM-5 molecular sieve was impregnated in the gallium nitrate solution at 60° C. for 4 h, to obtain an impregnated HZSM-5 molecular sieve. After impregnation, the impregnated HZSM-5 molecular sieve was then dried at 100° C. for 16 h, and finally calcined at 550° C. for 6 h, to obtain gallium supported HZSM-5 molecular sieve catalyst with the gallium loading amount of 10 wt %.

10 g of a smashed waste mask was put onto a fixed bed, and then 1 g of 10 wt % gallium supported HZSM-5 sieve catalyst as described above was added onto the fixed bed. After uniformly mixing, the resulting mixture was subject to a catalytic pyrolysis reaction in nitrogen protective atmosphere with a nitrogen flow rate of 250 mL/min at a temperature of 700° C. for 5 min. The pyrolysis reaction product was subjected to gas-liquid-solid separation to obtain a liquid phase product (i.e., hydrocarbon-rich fuel oil), gas and a small amount of pyrolysis carbon.

### Example 9

A gallium nitrate solution was prepared by dissolving 7.32 g of gallium nitrate in 150 mL of deionized water. 20 g of calcined HZSM-5 molecular sieve was impregnated in the gallium nitrate solution at 60° C. for 4 h, to obtain an impregnated HZSM-5 molecular sieve. After impregnation, the impregnated HZSM-5 molecular sieve was then dried at 100° C. for 16 h, and finally calcined at 550° C. for 6 h, to obtain a gallium supported HZSM-5 molecular sieve catalyst with the gallium loading amount of 10 wt %.

5 g of a smashed waste mask was put onto a fixed bed, and then 1 g of 15 wt % gallium supported HZSM-5 sieve catalyst as described above was added onto the fixed bed. After uniformly mixing, the resulting mixture was subjected to a catalytic pyrolysis reaction in nitrogen protective atmosphere with a nitrogen flow rate of 400 mL/min at a temperature of 500° C. for 30 min. The pyrolysis reaction product was subjected to gas-liquid-solid separation to obtain a liquid phase product (i.e., hydrocarbon-rich fuel oil), gas, and a small amount of pyrolysis carbon.

### Comparative Example 1

1 g of a smashed waste mask was put onto a fixed bed, and then 1 g of HZSM-5 sieve catalyst was added onto the fixed bed. After uniformly mixing, the resulting mixture was subjected to a catalytic pyrolysis reaction in nitrogen protective atmosphere with a nitrogen flow rate of 100 mL/min at a temperature of 550° C. for 15 min. The pyrolysis reaction product was subjected to gas-liquid-solid separation to obtain a liquid phase product (i.e., hydrocarbon-rich fuel oil), gas, and a small amount of pyrolysis carbon. The liquid phase product was subjected to GCMS detection. The product distribution results obtained are shown in Table 1.

### Comparative Example 2

1 g of a smashed waste mask was put onto a fixed bed. The resulting product was subjected to a catalytic pyrolysis reaction in nitrogen protective atmosphere with a nitrogen flow rate of 100 mL/min at a temperature of 550° C. for 15 min. The pyrolysis reaction product was subjected to gas-liquid-solid separation to obtain a liquid phase product (i.e., hydrocarbon-rich fuel oil), gas, and a small amount of pyrolysis carbon. The liquid phase product was subjected to GCMS detection. The product distribution results obtained are shown in Table 1.

TABLE 1
The product distribution results of the hydrocarbon-rich fuel
oil obtained in Examples 1-7 and Comparative Examples 1-2

| | Content (%) | | | |
|---|---|---|---|---|
| | Monocyclic | | | Polycyclic |
| Example | aromatic | | | aromatic |
| Number | hydrocarbons | Alkene | Alkane | hydrocarbons |
| Example 1 | 70 | 4.85 | 7.94 | 8.26 |
| Example 2 | 52.25 | 62.01 | 9.87 | 2.69 |
| Example 3 | 60.85 | 3.01 | 15.89 | 5.28 |
| Example 4 | 55.93 | 8.01 | 19.33 | 2.57 |
| Example 5 | 60.53 | 51.92 | 17.27 | 6.39 |
| Example 6 | 65.17 | 11.96 | 13.19 | 3.61 |
| Example 7 | 74.55 | 5.87 | 8.52 | 8.15 |
| Comparative | 52.71 | 14.75 | 18.37 | 6.83 |
| Example 1 | | | | |
| Comparative | 0 | 61.17 | 7.94 | 8.26 |
| Example 2 | | | | |

As can be seen from Table 1, in Comparative Example 2 without any catalyst, the liquid phase product obtained by pyrolysis reaction of the waste mask does not contain monocyclic aromatic hydrocarbons. In Comparative Example 1 with a HZSM-5 molecular sieve catalyst, the liquid phase product contains 52.71% monocyclic aromatic hydrocarbons; this is due to the facts: HZSM-5 molecular sieve can promote the secondary cracking of long chain hydrocarbons, and there are acidic sites in HZSM-5 molecular sieve, under the action of acidic sites, hydrocarbons produced by pyrolysis is converted to monocyclic aromatic hydrocarbon(s) through isomerization, cyclization and further dehydrogenation. HZSM-5 molecular sieve catalysts are modified in Examples 1-7. Different kinds of metals are supported on HZSM-5 molecular sieve in Examples 1-5, and it is found that gallium supported HZSM-5 molecular sieve catalysts have the highest selectivity for monocyclic aromatic hydrocarbons, which could reach 70%. In Examples 6-7, HZSM-5 molecular sieves are modified with different loading amounts of gallium. With the increase of loading amount, the content of monocyclic aromatic hydrocarbons in pyrolysis oil increases, up to 74.55%. Therefore, waste masks can be catalytically pyrolyzed by HZSM-5 molecular sieve loaded with 15 wt % gallium to prepare pyrolysis oil rich in aromatic hydrocarbons. In addition, zinc-, nickel-, iron- or copper-supported HZSM-5 sieve catalysts can also improve the selectivity of monocyclic aromatic hydrocarbons.

As can be seen from the above examples, in the present disclosure, provided is a method for preparing aromatic hydrocarbon-rich pyrolytic oil by catalytic pyrolysis of waste masks, comprising the following steps:
mixing a waste mask with a metal supported HZSM-5 molecular sieve catalyst, and carrying out a catalytic pyrolysis reaction in a protective atmosphere to obtain the aromatic hydrocarbon-rich fuel oil. The metal supported HZSM-5 molecular sieve catalyst used in the method could improve the selectivity for monocyclic aromatic hydrocarbons, thereby realizing the resource utilization of discarded disposable masks. The method has a simple and clean production process. Also, the reaction temperature could eliminate virus, thereby preventing secondary pollution.

The foregoing is only preferred embodiments of the present disclosure, and it should be noted that, for those skilled in the art, several modifications and embellishments may be made without departing from the principles of the present disclosure, which are also to be considered as the scope of the present disclosure.

What is claimed is:

1. A method for preparing an aromatic hydrocarbon-rich pyrolytic oil by catalytic pyrolysis of a waste mask, comprising the steps of:
mixing the waste mask with a catalyst to form a mixture; and
subjecting the mixture to a catalytic pyrolysis reaction in a protective atmosphere to obtain the aromatic hydrocarbon-rich pyrolytic oil;
wherein the catalyst is a metal supported HZSM-5 molecular sieve catalyst.

2. The method according to claim 1, wherein a metal in the metal supported HZSM-5 molecular sieve catalyst is one or more selected from the group consisting of gallium, zinc, nickel, iron and copper, and has a loading amount of 1-20 wt %.

3. The method according to claim 2, wherein the metal supported HZSM-5 molecular sieve catalyst is prepared by a process comprising
subjecting an HZSM-5 molecular sieve to impregnation in a metal salt solution to obtain an impregnated HZSM-5 molecular sieve; and
subjecting the impregnated HZSM-5 molecular sieve to drying and calcination sequentially to obtain the metal supported HZSM-5 molecular sieve catalyst.

4. The method according to claim 3, wherein the metal salt solution is prepared from a metal salt and water, wherein a solid-liquid ratio of the metal salt to water is in a range of (3-12) g: (150-250) mL, and the metal salt is one or more selected from the group consisting of gallium nitrate, zinc nitrate, nickel nitrate, iron nitrate and copper nitrate.

5. The method according to claim 4, wherein the impregnation is conducted at a temperature of 60-85° C. for 4-6 h.

6. The method according to claim 3, wherein the drying is conducted at a temperature of 100-120° C. for 12-24 h.

7. The method according to claim 6, wherein the calcination is conducted at a temperature of 500-600° C. for 4-8 h.

8. The method according to claim 1, wherein a mass ratio of the waste mask to the catalyst is in a range of 1:1 to 10:1.

9. The method according to claim 8, wherein the protective atmosphere is provided by nitrogen or argon, with a flow rate of 100-400 mL/min.

10. The method according to claim 9, wherein the catalytic pyrolysis reaction is conducted at a temperature of 500-700° C. for 5-30 min.

11. The method according to claim 4, wherein the drying is conducted at a temperature of 100-120° C. for 12-24 h.

12. The method according to claim 5, wherein the drying is conducted at a temperature of 100-120° C. for 12-24 h.

13. The method according to claim 2, wherein a mass ratio of the waste mask to the catalyst is in a range of 1:1 to 10:1.

14. The method according to claim 4, wherein a mass ratio of the waste mask to the catalyst is in a range of 1:1 to 10:1.

15. The method according to claim 5, wherein a mass ratio of the waste mask to the catalyst is in a range of 1:1 to 10:1.

16. The method according to claim 7, wherein a mass ratio of the waste mask to the catalyst is in a range of 1:1 to 10:1.
